(19) United States
(12) Patent Application Publication
(10) Pub. No.: US 2004/0064406 A1
(43) Pub. Date: Apr. 1, 2004

(54) Transaction authentication

(76) Inventors: Martin J Yates, Ipswich (GB); Stephen M Thompson, Woodbridge (GB); Nicholas H Edwards, Ipswich (GB); Maurice M Gifford, Ipswich (GB); David J McCartney, Ipswich (GB)

Correspondence Address: Nixon & Vanderhye, 8th Floor, 1100 North Glebe Road, Arlington, VA, 22201-4714, US

(21) Appl. No.: 10/415,274

(22) PCT Filed: Nov. 1, 2001
(86) PCT No.: PCT/GB01/04836

(30) Foreign Application Priority Data
Nov. 1, 2000 (EP) 00309635.1
Sep. 14, 2001 (GB) 0122249.6

(51) Int. Cl. G06F 17/60; G06F 17/00

(52) U.S. Cl. 705/40; 705/26; 700/232

(57) ABSTRACT

In a payment validation system, a mobile phone or other communications terminal associated with a particular user is used. A vending node communicates with a validation platform which either returns a telephone number to be displayed for the user to call or which calls the alleged users phone or terminal for confirmation.

The present invention relates to transaction authentication and more particularly to a method of and system for authentication of transactions authorised by remote communication.

Vending machines are vulnerable to losses arising from illicit activity, for example by direct theft of cash held therein and/or by fraudulent payment card usage. Further problems occur for consumers who may require to have exact coin combinations in order to purchase, machine-vended goods or services.

Similarly, there is a public perception that transactions performed by way of the world-wide-web (the Internet) are inherently insecure such that there may be a reluctance to enter credit or debit card details even although an allegedly secure transaction server is involved.

Many consumers now carry portable communications apparatus including cellular telephones and portable (palmtop) personal computers capable of wireless communication through an appropriate service provider. In addition to such capability such apparatus may also be adapted to communicate within a local area using infra-red transmission or low power radio signal (e.g. Bluetooth, trademark).

According to one aspect of the present invention there is provided a method of validating a payment transaction comprising the steps of transmitting through a communications network a request message from a vending node to a transaction authorisation function, said request message identifying a communications node identity, said transaction authentication function using said communications node identity to establish a communications session with said communications node and transmitting a notification message thereto, said notification message instructing a confirmation response, said transaction function determining from the confirmation response whether the transaction is valid and, if so, transmitting an authorisation message to said vending node.

According to a second aspect of the present invention there is provided a method of validating a payment transaction comprising the steps of transmitting through a communications network a request message from a vending node to a transaction authorisation function said request message identifying variable information displayed at said vending node, said transaction authorisation function monitoring a communications network node for receipt of a transaction confirmation message from communications apparatus and, on receipt of a transaction confirmation message determining whether the transaction is valid and, if so, transmitting an authorisation message to said vending node.

Preferably the geographical location of the vending node is compared with the geographical location of the communications apparatus prior to transmitting the authorisation message.

The vending node may be adapted to display a communications node address selected from a plurality of communications node addresses such that the consumer contacts the monitored communications node address which is transmitted by the vending node to the transaction authentication function in said request message. Alternatively or additionally the vending node may display a transaction identification message to be transmitted by the communications apparatus to the transaction authentication function, the request message including the transaction identification message.

Prior to transmitting the authorisation message, the transaction authorisation function may require the transmission of a personal identification code known to an authorised consumer associated with the transmitting communications apparatus and to the transaction authentication function. Such may be in the form of a Personal Identification Number (PIN) code or an alpha- or alphanumeric code.

The transaction authorisation function may carry out other validity checks in respect of the proposed transaction including, but not limited to, determining whether the account accessed has sufficient credit for the transaction. Authorisation may be withheld for certain vended products or services if the account holder has added restrictions to allowed purchases.

Other features of the invention will be apparent from the description which follows.

Embodiments of the invention will now be described by way of example only with reference to the accompanying drawings of which:

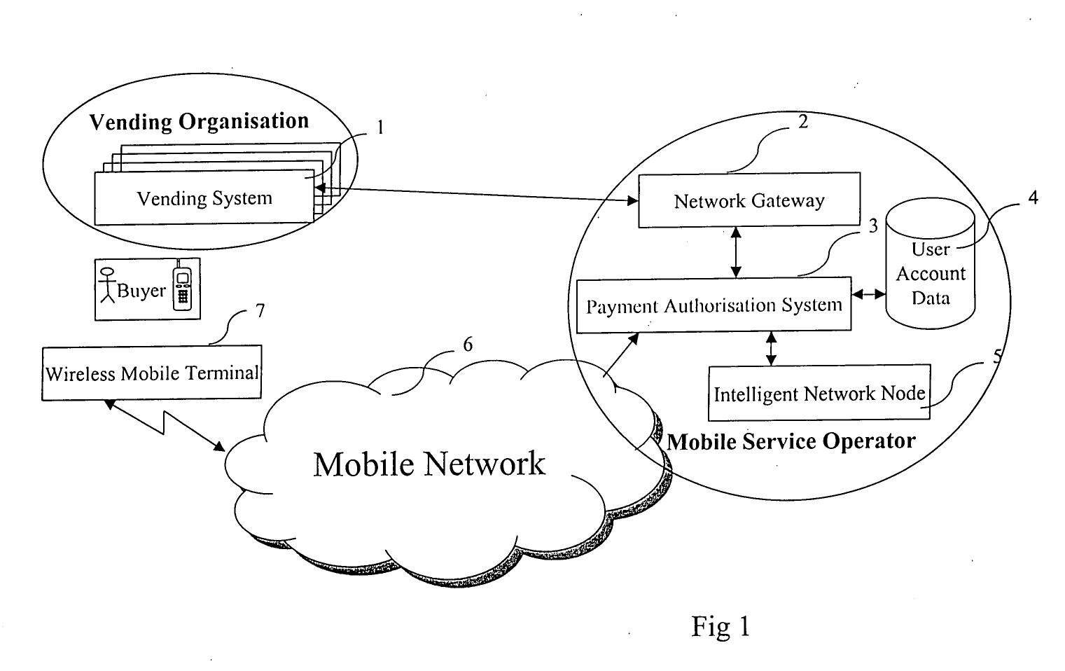

FIG. 1 is a block schematic diagram of a transaction authentication system using the method of the invention; and

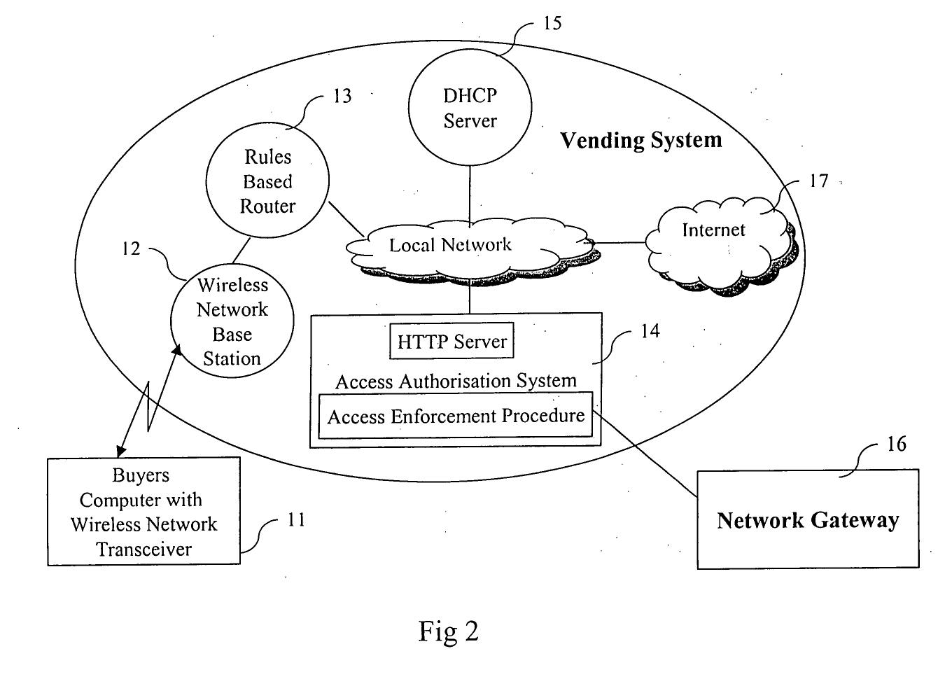

FIG. 2 is a block schematic diagram showing a part of FIG. 1 in greater detail.

In the growth of mobile e-commerce there is pecuniary advantage to allow companies selling chargeable goods, information and services to charge and bill for those items via their customers' wireless network service supplier. An example is a vending machine operator having machines which dispense items when a financial transaction has occurred. The vending machine operator will charge the cost of the item to the customers mobile phone prepay or credit account or any other pre-arranged payment system such as credit-card.

In these circumstances security is an essential feature and there is a need for the vendor and the mobile service operator to agree and authorise the transaction even though they may be completely separate commercial entities operating their systems in separately secured environments. Important information that contributes to the authorisation and auditing of transactions is evidential agreement that a uniquely identifiable transaction is occurring at a known location, at a known time, with a known person uniquely associated with the chargeable account. Furthermore a characteristic is that the business systems that dispense the chargeable goods or services are commercially separate from the systems that operate and bill customers of the mobile networks.

The invention provides a solution to enable a vendor, mobile service operator and buyer (who is also a user of the mobile service operator for example) to complete a secure transaction. This system is shown in FIG. 1 to which reference is now made. A vending system 1 may comprises a single physical entity (e.g. a vending machine) or could comprise a dispensing machine networked to a central control system. The vending system 1 can display purchasing information to the person buying. The vending system 1 has communication capability with a transaction authorisation system 3 via a network gateway 2. The network gateway 2 accepts and sends a defined set of messages or commands that are passed to the transaction authorisation system 3.

The role of the network gateway 2 is to ensure only authorised vending systems 1 can communicate with the transaction authorisation system 3 and that the communication is secure. The transaction authorisation system 3 contains data about the users that relate information such as the phone number, account number, monetary credit limit, monetary balance, unique terminal identity (typically a SIM card in the GSM standard), and personal identity number (PIN) as further described hereinafter with reference to FIG. 2. Thus the transaction authorisation system 3 receives a transaction request via the network gateway 2 and then ensures that the transaction system 3 authorises the transaction. This may be done in several ways.

A key part of the authorisation is the use of an intelligent network node 5 capable of making calls to or receiving calls from the user and conducting a dynamically created, automated dialogue with the user.

Two modes of operation are now considered, the first in which the transaction is authorised by the network node 5 effecting the establishment of a call to a wireless mobile terminal 7 associated with the alleged buyer. In this mode the vending system 1 is capable of accepting input from the buyer, for example by way of a keypad, so that the buyer can select a purchasable item and input his mobile terminal address (for example a mobile telephone number).

It will be appreciated that any appropriate communication node address associated with the purchaser may be used in lieu of a mobile telephone number. Other examples include an email address, SMS messaging, Session Initiation Protocol address (SIP) or address of any other personal terminal of a portable or transportable nature.

For the avoidance of doubt, where a purchase is made by use of a Personal Computer (PC) acting in vending mode for example for purchases via a web-site, a fixed telephone number (land line telephone number) may also be used as a reference to the individual user.

The buyer selects an item to buy from the vending system 1 and inputs his mobile telephone address. The vending system displays a unique alphanumeric sales order number for the transaction together with price. The vending system 1 authenticates itself to the network gateway 2 which, optionally, responds with its own authentication so that the vending system 1 establishes a secure communications session (if authorised to do so by the network gateway 2). The vending system 1 sends to the network gateway 2 a defined message requesting a transaction to be authorised. The message contains the mobile terminal address as entered by the buyer, purchase description, purchase price, and (optionally) the geographic location of the vending system.

Note that the geographical location of the vending machine may be pre-programmed to the vending service or may be derived from (e.g.) a global positioning system device responsive to multiple satellite signals. Alternatively, where the communication between the vending system 1 and the network gateway 2 is by way of a cellular communication or low earth orbital satellite communication triangulation may be used by the network operator to confirm the geographical placement.

The network gateway 2 forwards a message to the transaction authorisation system 3 requesting the transaction to be confirmed. The message contains the wireless mobile terminal address, purchase description, purchase price, vending system geographic location and vending system identity. The vending system identity is that identity authenticated by the network gateway 2.

The transaction authorisation system 3 will take a number of actions according to the policy defined for the chargeable account associated with the mobile terminal address in a database 4. Such actions may include any or all of the following checks:

The account is checked to ensure the credit limit or credit/prepayment available is not exceeded by the purchase.

The network terminal location system (for example the cellular network mast through which the transaction is being verified) will be requested for the geographic location of the mobile terminal address specified for the purchase. The terminal location must match the vending machine location within the error of the positioning system. This helps prevent misuse. If approved the transaction proceeds to the next step.

A secret PIN (personal identity number) (or where the mobile terminal is more sophisticated an alpha- or alphnumeric password) known only to the mobile service operator and an authorised user of the account is read from the database.

Where a voice communication terminal is in use, the transaction authorisation system 3 constructs an interactive message using a voice XML language and passes this together with the mobile terminal address to the Intelligent network node 5. The message is used to construct a dialogue with the buyer. The dialogue will explain the vendor identity, purchase description, purchase price and ask the buyer to input to the mobile terminal the unique order number displayed on the vending system and the buyer's secret PIN.

In an alternative to entry of the PIN via the mobile terminal, the PIN may be entered on a keypad at the vending terminal. In a further development, the voice message to the user will transmit an authorisation number to the user for entry to the vending machine keypad.

Accordingly, the intelligent network node 5 converts the VXML message to speech using a text to speech converter, calls the mobile phone address and when answered by the buyer will play the interactive message and collect the buyer input.

In one mode of operation the buyer inputs information using (Dual Tone Multi Frequency) DTMF tones, in another mode oral input is used and a voice recognition peripheral associated with the intelligent network node will recognise the speech and converts accordingly. At this stage a further level of security may be introduced for higher value transaction using for example voice-print comparison as a further check. Other biometric parameters may also be used, for example by including a scanner at the vending terminal iris recognition could be used or a fingerprint scan. Signature checking may also be included using a stylus and pressure sensitive pad.

The dialogue may include standard features not specific to the transaction to allow the user to correct or confirm his input. The input unique sales number and PIN are returned to the transaction authorisation system.

It will be appreciated that where the user has a more sophisticated mobile terminal, such as a palmtop personal computer (ppc) for example conversion of the messages between the terminal 7 and the intelligent network node 5 by way of the mobile network 6 is not required and validation will be on the basis of an output alpha-numeric instruction message to the user and an alpha-numeric return message form the user. The required messaging format may be a function of the information stored in the database 4 in respect of the mobile address.

Whether the terminal is for voice or data useage, the transaction authorisation system will then verify the correctness of the unique sales order number and the PIN or password entered. If both of these are correct the transaction is approved and a transaction authorised message is sent to the network gateway 2. This message contains the unique sales order number, purchase description and purchase price.

The network gateway 2 relays the transaction approved message to the vending system 1 over the previously established secure session. This message contains the unique sales order number, purchase description and purchase price.

The vending machine then dispenses the requested product or service. A transaction complete message is then sent back to the network gateway 2 over the secure connection. This message contains the unique sales order number, purchase description and purchase price

The network gateway 2 will pass a transaction complete message to the transaction authorisation system 3, the message containing the unique sales order number, purchase description and purchase price, and authenticated vendor system identity. The transaction authorisation system then deducts the purchase amount from the mobile service account or from another authorised payment account.

In an alternative mode of operation, instead of entering a mobile terminal address toteh vending system 1, the buyer enters a chargeable account number. In this case the mode continues as before with the mobile terminal address substituted by the account number. Thus the account number is used to retrieve from the account database 4 an associated mobile terminal address. This may increase the security significantly because the account number is not generally known.

In a further alternative mode of operation where the wireless mobile terminal 7 is capable of direct communication (for example by way of an infra red port) with a vending system then the mobile terminal network address may be transmitted directly to a receiving port of the vending machine which then enables further automation of the vending process.

A further alternative way of effecting the transaction may use the mobile terminal to effect most of the purchasing process. Thus, the payment authorisation system 3 may include details of the products/services and pricing associated with the vending system 1. The buyer may thus only be required to cause transmission of information giving the network mobile address of the wireless terminal 7. The whole of the rest of the transaction including identifying the required product to be vended, product pricing and the like may be carried out in a central processor, the vending system 1 receiving a message to dispense the required product and returning a product dispensed message to the network gateway 2.

It will also be noted that in a more sophisticated system, the database 4 may hold permitted purchase information in the database 4 whereby the products/services dispensed by the vending system 1 can be restricted. For example, where a parent has established a prepay or post payment (credit) account for the benefit of a child, cigarette or alcohol purchases may be barred such that while certain items from a vending system may be permitted to be dispensed, restricted item sales are not authorised.

Turning now to an alternative mode of operation the vending system may be less complex and does not require mobile terminal address or account input by the buyer. This may improve security further because the information is not disclosed. This mode requires that the buyer has enabled a network authenticated mobile terminal identity to be forwarded by the network when calls are made from the mobile terminal 7. The buyer is required to have arranged in advance a secret PIN that identifies authorised users of the mobile service account associated with the mobile terminal identity.

In this method of operation, a buyer selects an item to purchase from the vending system. The vending system displays a telephone network number for the buyer to dial using his mobile terminal. The telephone number may be chosen pseudo-randomly from a range of addresses.

Alternatively the vending system can display an invariant telephone network address and a randomly generated password number to enter after the call is entered. For higher security the vending system might display both the pseudo-random telephone network number and the randomly generated password.

Possible telephone network numbers are agreed in advance between the vending system operator and the transaction authorisation system operator and corresponds to a network address that the transaction authorisation system controls.

The vending system authenticates 1 to the network gateway and establishes a secure communications session as previously described The vending system 1 forwards a request message to the network gateway 2 to authorise the payment, the message contains the displayed telephone network number, displayed random password number, purchase description (optional), purchase price (optional), and vending system geographic location (optional) to the network gateway 2.

As before, the network gateway 2 sends a message to the transaction authorisation system 3 requesting the transaction to be confirmed. The message contains the telephone network number, random password number, purchase description, purchase price, geographic location (optional), and vending system identity. The vending system identity is that identity authenticated by the network gateway 2.

The transaction authorisation system 3 constructs a command to the intelligent network node 5 to activate a call-in procedure to verify the validity of the purchase. The command describes the vendor identity, purchase description, purchase price, the associated random password, whether a PIN is expected, and the network address termination to monitor for the buyer's expected call.

The intelligent network node 5 procedure will start to monitor the expected dial-in network address termination. This monitoring may have a time-to-live which may be displayed on the vending system for the buyer, and if the buyer has not called the number before the expiry of the time out the transaction is refused.

The buyer dials the telephone number (using the pre-authorised wireless mobile terminal) and the call is answered by the intelligent network node which also receives the network authenticated mobile terminal identity (eg Calling Line Identity (CLI)). This identity is passed immediately back to the transaction authorisation system.

The transaction authorisation system will take a number of actions according to the policy defined for the chargeable account. These may include using the calling mobile terminal identity to obtain account details from the database 4.

The account is checked to ensure the available credit limit is not exceeded by the purchase.

The network terminal location system in the network may be requested for the geographic location of the mobile terminal address specified for the purchase. The terminal location must match the vending machine location within the error of the positioning system.

The buyer's secret PIN or password may be read from the database if required.

Provided the account policy will allow the transaction in principle the intelligent network node is sent a message to continue and is passed the PIN if required. Otherwise the procedure is instructed to inform the buyer the transaction has failed.

If transaction is approved in principle a speech dialogue is dynamically created and played to the buyer (or transmitted in alpha numeric or alpha format as appropriate) to explain the vendor identity, purchase description, purchase price and requests the random number password and the buyer's PIN number. When these data are entered by the buyer the procedure will verify the accuracy of the information. In one embodiment the buyer inputs the random number and PIN using the public phone network standard DTMF tones. In another refinement the buyer can speak the digits and these are recognised using speech recognition in the node. In another refinement pattern samples of buyers speech are retrieved from the account database and passed to the node procedure along with the PIN. The buyers speech input is analysed and compared to the pre-recorded samples to check the authenticity of the buyer.

The intelligent network node 5 will announce to the buyer whether the transaction is approved or denied, and return a message to the network gateway explaining whether the transaction is accepted or denied and the reason.

The network gateway will relay the outcome and reason to the vending system.

The vending system will dispense the product or service if approved and return a transaction complete message to the network gateway.

The network gateway will relay this message to the transaction approval system and the account is charged the transaction price. The emergence of wireless network technology such as the IEEE 802.11 and ‘Bluetooth’ standards has created an opportunity for organisations to install wireless network base-stations for the benefit of customers in the vicinity of the base-station who wish to use portable computers enabled with wireless network transceivers to access other computers, for example on the Internet. The use of a base-stations by an individual customer can be charged using the customer's mobile phone to secure the payment transaction. In this circumstance the vending system comprises a number of components shown in FIG. 2, to which reference is now made.

The buyer's computer 11 will attach to the wireless network base-station 1 2 using its wireless network interface transceiver. A low level communications channel is opened between the buyer's computer and a rules based router 13. At this stage the rules based router 13 will only permit traffic to flow between the computer and the DHCP server (Dynamic Host Configuration Protocol) 15 and the HTTP or Web browser. All other network communications to or from the computer are discarded by the router 13.

In the case of networking using the internet protocol IP, the buyer's computer sends a request to a DHCP server 15 for an Internet Protocol IP address. The DHCP server allocates an IP address and returns this to the computer. The computer can then communicate with other computers using IP based protocols provided the rules based router 1 3 will permit the traffic to pass.

The buyer starts a web browser application on the computer 11 and attempts to communicate with any website on the internet 7. The rules based router 1 3 will intercept the web request (usually made over Hyper-Text Transfer Protocol HTTP) and redirect this to the access control server 14 which will return a web display showing the buyer information about how to pay for wireless network access.

The browser display is now synonymous with the vending system display described previously and the payment for the network access is authorised in exactly the same way as any other dispensed product or service, according to the two possible modes of operation described above. The wireless access may be priced differently according to the permitted terms of service hereinbefore described or authorised dispensing level which may be used to control access to certain material on the Internet.

When payment has been authorised the access authorisation system 14 will communicate securely over the network with the router 1 3 to update the rule set. The new rules will permit traffic to pass between the computer 11 and the worldwide Internet 7 according to the constraints of the rules. The rules may vary any combination of for example allowable network protocols, cumulative data volume, maximum peak data rate, current network demand from all computers, expiration time/date and time for the access.

When the network access service purchased from the system has been provided (as enforced by the router 1 3) the router will return to the default rules allowing only communication between the computer 11 and the DHCP server 15 and the access authorisation system 1 4 as previously described.

Note that the network gateway 16 of FIG. 2 performs the same function as the network gateway 2 of FIG. 1 and will cause the payment authorisation functionality previously described to be carried out.

Parts of the present system may result in screen based communication of network telephone addresses to be called and/or passwords or PIN's to be entered from a pre-authorised mobile telephone associated with the authorised user of the communicating portable computer. Further particulars of the secure access system used for authorising portable computers by an associated mobile telephone (which may provide a PIN or password to be entered via the computer keyboard may-be found in co-pending European patent application number 00309635.1

1. A method of validating a payment transaction comprising the steps of transmitting through a communications network a request message from a vending node to a transaction authorisation function, said request message identifying a communications node identity, said transaction authentication function using said communications node identity to establish a communications session with said communications node and transmitting a notification message thereto, said notification message instructing a confirmation response, said transaction function determining from the confirmation response whether the transaction is valid and, if so, transmitting an authorisation message to said vending node.

2. A method of validating a payment transaction comprising the steps of transmitting through a communications network a request message from a vending node to a transaction authorisation function said request message identifying variable information displayed at said vending node, said transaction authorisation function monitoring a communications network node for receipt of a transaction confirmation message from communications apparatus and, on receipt of a transaction confirmation message determining whether the transaction is valid and, if so, transmitting an authorisation message to said vending node.

3. A method of validating a payment transaction as claimed in claim 1 or claim 2 in which the geographical location of the vending node is compared with the geographical location of communications apparatus prior to transmitting the authorisation message.

4. A method of validating a payment transaction as claimed in claim 2 in which the vending node is adapted to display a communications node address selected from a plurality of communications node addresses such that the consumer contacts the monitored communications node address which is transmitted by the vending node to the transaction authentication function in said request message.

5. A method of validating a payment transaction as claimed in any preceding claim in which the vending node may displays a transaction identification message to be transmitted by the communications apparatus to the transaction authentication function, the request message including the transaction identification message.

6. A method of validating a payment transaction as claimed in any preceding claim in which, prior to transmitting the authorisation message, the transaction authorisation function requires the transmission of a personal identification code known to an authorised consumer associated with the transmitting communications apparatus and to the transaction authentication function.

7. A method of validating a payment transaction as claimed in claim 6 in which the personal identification code is in the form of a Personal Identification Number (PIN) code or an alpha- or alphanumeric code.

8. A method of validating a payment transaction as claimed in any preceding claim in which the transaction authorisation function determines, prior to transmitting the authorisation message, whether the account accessed has sufficient credit for the transaction.

9. A method of validating a payment transaction as claimed in any preceding claim in which the product requested is compared with a list of restricted articles associated with the account accessed and the authorisation message is withheld or modified to prevent the dispensing of the requested vended products or services.
